(19) United States
(12) Patent Application Publication
(10) Pub. No.: US 2017/0167801 A1
(43) Pub. Date: Jun. 15, 2017

(54) HYGROSCOPIC COMPOSITE MATERIAL

(71) Applicants: Universite de Mons, Mons (BE); Universite Libre de Bruxelles, Bruxelles (BE)

(72) Inventors: Emilie COURBON, Mons (BE); Marc FRERE, Mons (BE); Nicolas HEYMANS, Mons (BE); Pierre D'ANS, Bruxelles (BE)

(73) Assignees: Universite de Mons, Mons (BE); Universite Libre de Bruxelles, Bruxelles (BE)

(21) Appl. No.: 15/321,593

(22) PCT Filed: Jun. 25, 2015
(86) PCT No.: PCT/EP2015/064449

§ 371 Date: Dec. 22, 2016

(30) Foreign Application Priority Data
Jun. 25, 2014 (GB) 1411286.6
Oct. 3, 2014 (GB) 1417530.1

(51) Int. Cl. F28D 20/00; C09K 5/16

(52) U.S. Cl. CPC F28D 20/003; C09K 5/16; F28D 20/0043

(57) ABSTRACT

A composite material, notably for seasonal storage of energy in a domestic heating system, comprises grains having at least one of the following pairings of hygroscopic salt arranged within a porous material (table) with the hygroscopic metal concentration in the central zone of the grain being at least 0.7 times that in the peripheral zone.

The present invention relates to a composite material comprising a hygroscopic salt arranged within a porous material and to the use of such a material for energy storage.

According to one of its aspects, the present invention provides a composite material as defined in claim 1. Additional aspects are defined in other independent claims. The dependent claims define preferred and/or alternative embodiments.

The composite materials of one aspect of the invention are particularly suited for long term storage of energy, notably during a period of one to nine months. One application is for storage of thermal energy produced, for example by solar collectors, during the summer and subsequent controlled release of this energy to heat a building during the winter. The system may be used to store energy prior to its subsequent release for a period of at least 168 hours (about one week), at least 672 hours (about four weeks), at least 2016 hours (about 12 weeks) or at least 4032 hours (about 24 weeks).

During energy collection, heating of a hydrated form of the hygroscopic salt leads to its dehydration and water vapour generated may be condensed and stored in a tank. For energy release, contacting a dehydrated form of the hygroscopic salt with water vapour releases hydration energy in the form of heat which may be transferred using a carrier gas. During a dehydration/hydration cycle the salt is likely to be subject to morphological changes (for example, partial liquefaction or aggregation of salt particles) which may affect the reliability of the storage system. Incorporating the salt in a porous material mitigates associated problems and facilitates contact between the salt and its surrounding atmosphere.

The porous material preferably acts to support the hygroscopic salt and/or acts as a physical adsorbent for water vapour. The hygroscopic salt is preferably dispersed substantially homogeneously in the porous material but without completely filling the porosity; this allows a large amount of salt to be supported whilst facilitating accessibility for exchange of water vapour between the salt and its surrounding atmosphere.

The form of grains facilities incorporation of the material in an energy storage system and provides a large surface area which also facilitates contact between the composite material and its surrounding atmosphere. The grains may have an average diameter of at least 50 μm and/or less than 3 mm.

The average pore diameter of the porous material may be at least 1 nm or 2 nm; it may be less than or equal to 30 nm or 15 nm. The total pore volume of the porous material may be at least 0.2 cm³/g or 0.3 cm³/g and/or less than or equal to 2 cm³/g or 1.5 cm³/g. The active surface area may range from 200 to 800 m²/g, preferably from 300 to 550 m²/g or from 1000 to 1500 m²/g, preferably from 1200 to 1300 m²/g.

The pairings of porous material and hygroscopic salt of certain aspects of the invention have been found particularly suitable for achieving desirable levels of water adsorption and/or desorption and/or for allowing desirable quantities of hygroscopic salt to be carried by the composite materials.

In particular, it has surprisingly been found that a significant quantity of the salt can be introduced and/or retained at or towards the central zone of the grains. Whilst not wishing to be bound by theory, it is believed that this aspect contributes to providing high levels of water adsorption, notably by allowing the interior of the grains (and not just their surface portions) to carry significant quantities of the salt whilst allowing access to the salt at the interior of the grain for adsorption and desorption of water vapour. It is also thought that preventing the formation of a layer of salt and/or blocked pores at the surface of the grains which would restrict access to the interior of the grains enhances performance of the composite material.

Where the water adsorption is expressed in g/g this represents grams of water adsorbed per gram of dehydrated composite material. The water adsorption is an indication of the amount of water that a dehydrated form of the composite material can adsorb. The amount of energy released is a function of the amount of water adsorbed and the hydration energy of the hygroscopic salt(s) present in the composite material.

The water adsorption may be:

| | water adsorption | water adsorption |
|---|---|---|
| pairing of porous | measured between | measured between |
| material and | 80° C. and 30° C. | 80° C. and 30° C. |
| hygroscopic salt | at 12.5 mbar | at 20 mbar |
| activated carbon | at least 0.19 g/g, | at least 0.19 g/g, |
| and strontium | preferably at least | preferably at least |
| bromide | 0.20 g/g | 0.20 g/g |
| activated carbon | at least 0.28 g/g, | At least 0.44 g/g, |
| and calcium | preferably at least | preferably at least |
| chloride | 0.29 g/g | 0.45 g/g, |
| silicagel and | at least 0.35 g/g, | At least 0.60 g/g, more |
| calcium chloride | preferably at least 0.36 | preferably at least 0.62 |
| | g/g, more preferably at | g/g, more preferably at |
| | least 0.38 g/g | least 0.64 g/g |
| silicagel and | at least 0.18 g/g, | at least 0.25 g/g, |
| strontium | preferably at least 0.20 | preferably at least 0.26 |
| bromide | g/g, more preferably at | g/g, more preferably at |
| | least 0.21 g/g | least 0.28 g/g |
| silicagel and | at least 0.25 g/g, | at least 0.35 g/g, more |
| magnesium | preferably at least 0.26 | preferably at least 0.37 |
| chloride | g/g, more preferably at | g/g, more preferably at |
| | least 0.28 g/g | least 0.39 g/g |

Water adsorption of the composite material may be measured by thermogravimetry with adsorption isotherms. The dehydrated composite material is placed inside a thermogravimetry apparatus, for example a Seratam TG-DSC 111. Isotherms are measured by pressure stages and water vapour is thereafter incorporated in the composite material. The isotherms are generally measured from 100 Pa to 1800 Pa. Beyond this partial pressure, water vapour generally condenses inside the apparatus and the results may be erroneous. The measurements are preferably made at 30° C., 40° C., 60° C. and 80° C. In most applications the water adsorption is measured between 30° C. and 80° C. at the saturated vapour pressure at 10° C.

The hygroscopic salt may be trapped in the microporosity and/or the mesoporosity of the porous material; this may enhance the stability of the salt. Preferably, the pores of the porous material are not completely filled by the hygroscopic salt. This may facilitate accessibility of the salt within the porous material and/or allow the porous material to take part to the energy storage process by adsorbing and desorbing water vapour. The amount of hygroscopic salt of the composite material with respect to the total pore volume of the porous material may be no more than 95%, no more than 90%, no more than 85%, preferably no more than 80%.

The amount of hygroscopic salt of the composite material with respect to the total weight of the composite material may be:
At least 20% wt, preferably at least 25% wt, more preferably at least 29% wt for the pairing activated carbon and strontium bromide
At least 28% wt, preferably at least 30% wt, more preferably at least 32% wt for the pairing activated carbon and calcium chloride
At least 33% wt, preferably at least 35% wt, more preferably at least 38% wt for the pairing silicagel and calcium chloride
At least 40% wt, preferably at least 45% wt, more preferably at least 47% wt for the pairing silicagel and strontium bromide
At least 30%, preferably at least 35%, more preferably at least 38% for the pairing silicagel and magnesium chloride

The amount of hygroscopic salt of the composite material with respect to the total weight of the composite material may be determined by measuring the difference in weight between the porous material prior to impregnation and the impregnated composite material. Alternatively, the hygroscopic salt content can be measured by X-Ray Fluorescence or by other chemical analysis.

The water adsorption/desorption performance of the composite material preferably remains substantially constant over a plurality of cycles. This allows use of the composite materials in systems adapted to function over a large number of cycles and/or over a long duration, for example over a period of at least 5, 10 or 15 years. The difference in water adsorption of the composite material measured between 30° C. and 80° C. at 12.5 mbar between 5 successive cycles of adsorption and subsequent desorption, and preferably between 15 such cycles, may be less than 15%, preferably less 10%, more preferably less than 5%. This may be measured for the first 5 or 15 cycles of a previously unused composite material.

A preferred method of manufacturing a composite material comprises
Impregnating a porous material with a solution of a hygroscopic salt to form a composite material;
Subsequently drying the composite material in order to remove water;
Subsequently re-impregnating the composite material with a solution of a hygroscopic salt to form a composite material.

Preferably, the porous material is dried to remove water prior to the first impregnation. Additional steps of drying and subsequently re-impregnating the composite material may be used such that the method comprises a three step process (i.e. three impregnation steps, each impregnation step being separated by a drying step), a four step, five step, six step, seven step or eight step process, or a process comprising more than eight steps.

The solution of hygroscopic salt is preferably an aqueous solution. The concentration of the hygroscopic salt in the aqueous solution is preferably less than the saturation concentration of the hygroscopic salt, notably a concentration of not more than 95% or 90% of the saturation concentration; this reduces the risk of excessive deposition of the salt at the surface portion of the porous material and/or blocking access of the interior pores of the porous material for subsequent impregnations.

Drying of the porous or composite material may comprise heating in an oven, for example at 200° C. The mass of the porous or composite material may be measured periodically during drying; absence of a change of mass between two successive measurements may be taken as in indication that the material is substantially dehydrated. The drying duration may be about at least 4 hours, notably prior to the initial impregnation; it may be about at least 2 hours, notably between subsequent impregnations. The drying duration depends on the amount of composite material to be prepared.

During impregnation, the aqueous solution of the hygroscopic salt may be added to a recipient containing the dehydrated porous material. Preferably, the volume of the aqueous solution is substantially equal to the pore volume of the porous material; this helps to avoid deposition of hygroscopic salt on the external surface of the porous material and facilitates deposition in the pores of the porous material by capillary condensation. Preferably, the recipient containing the aqueous solution of the hygroscopic salt and the porous material is mixed during the impregnation, for example by shaking or agitation; this helps the homogeneity of the impregnation.

The impregnation step may be at ambient temperature. The duration of the impregnation may be at least 15, 30, 45, 60 or 120 minutes and/or less than 8 or 4 hours.

Each impregnation may use the same concentration of solution of hygroscopic salt and/or the same hygroscopic salt.

The composite material may be used for the storage and the recuperation of thermal energy in heating system, for example a domestic heating system. In use, the at least partially hydrated composite material may be at least partially dehydrated by subjecting it to a temperature in the range 30° C. to 150° C., preferably 40° C. to 120° C., more preferably 60° C. to 110° C., even more preferably 70° C. to 100° C. during a period of at least 10 minutes, 30 minutes or 45 minutes. The at least partially dehydrated composite material may be stored for a period of at least 30 minutes, at least 1 hour, at least 4 hours, preferably at least 4 days, more preferably at least 4 weeks, even more preferably at least 4 months prior to contact with water to release its hydration energy. The at least partially dehydrated composite material composite may be exposed to water, in vapour form, in order to rehydrate the composite material whilst removing the heat from the composite material at a temperature in the range 20° C. to 80° C., preferably 20° C. to 60° C., more preferably 30° C. to 50° C.

Non limiting examples are described below with reference to:

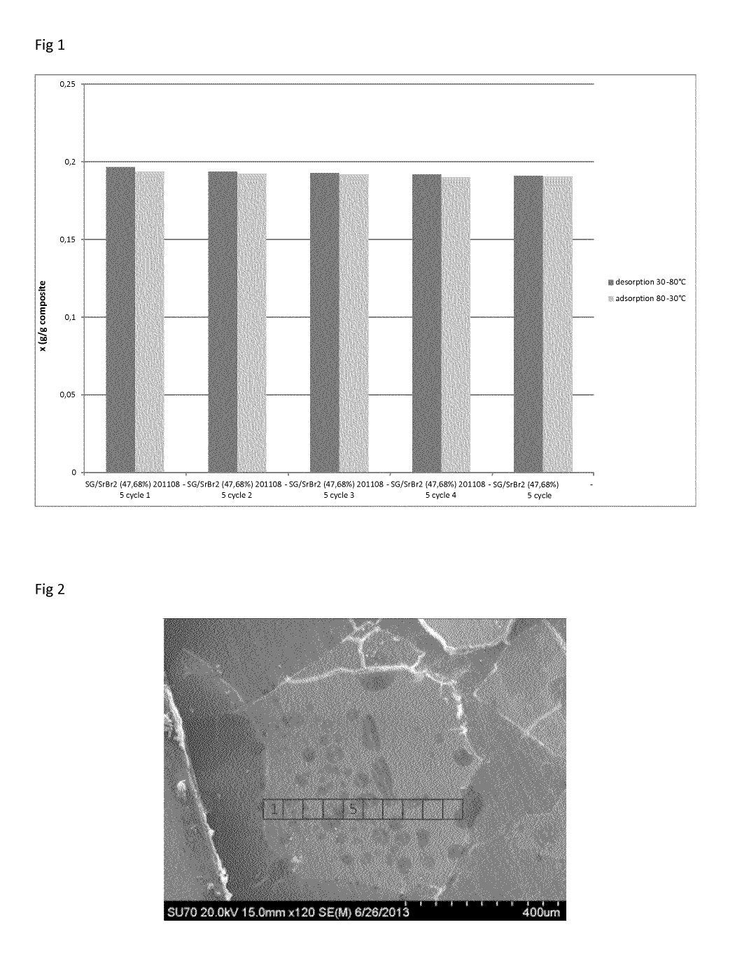

FIG. 1: a graph of water adsorption and desorption over successive cycles; and

FIG. 2: a cross-section through a grain of composite material.

### EXAMPLES 1-5

The composite materials of Table 1 were made by:
Dehydrating the porous material in an oven at 200° C. for 4 h until the mass of the porous material was constant;
Impregnating, with agitation, the dehydrated porous material during 30-60 minutes with a volume of an aqueous solution of the hygroscopic salt equal to the pore volume;
Dehydrating the composite material in an oven for 60 minutes at 200° C. (except for example 5 which was dehydrated at 110° C.);
Repeating the impregnation/drying cycle as indicated in Table 1

TABLE 1

| | | | | Final amount | | |
|---|---|---|---|---|---|---|
| | | | | of | | |
| | | | | hygroscopic | | |
| | | | | salt of the | | |
| | | | | composite | Water | Water |
| | | | | material in | adsorption | adsorption |
| | | Concentration | | the grains | measured | measured |
| | | of hygroscopic | | with respect | between | between |
| | | salt in solution | Number of | to the total | 80° C. and | 80° C. and |
| | | for the | impregnation | weight of the | 30° C. at | 30° C. at |
| Example | Pairing | impregnation | steps | grains | 12.5 mbar | 20 mbar |
| 1 | activated | 40% | 2 | 29.50% | 0.200 | 0.200 |
| | carbon/ | | | | | |
| | SrBr2 | | | | | |
| 2 | activated | 20% | 3 | 32.47% | 0.292 | 0.450 |
| | carbon/ | | | | | |
| | CaCl2 | | | | | |
| 3 | silicagel/ | 20% | 4 | 42.92% | 0.387 | 0.640 |
| | CaCl2 | | | | | |
| 4 | silicagel/ | 40% | 2 | 47.68% | 0.218 | 0.285 |
| | SrBr2 | | | | | |
| 5 | silicagel/ | 20% | 2 | 36.00% | 0.284 | 0.390 |
| | MgCl2 | | | | | |

The activated carbon SRD 10034 (AC) used has a specific surface of 1250 m²/g and a pore volume of 0.42 cm³/g. The silicagel SG 100 (SG) used has a specific surface of 360 m²/g and a porous volume of 0.8 cm³/g. Another type of silicagel may be used such as the silicagel SG 62 (SG) which has a specific surface of 320 m²/g and a porous volume of 1.15 cm³/g.

### Reproducibility Test

The composite material of Example 4 was tested during 5 successive adsorption/desorption cycles between 30° and 80° C. at 12.5 mbar. The results shown in FIG. 1 were measured by a thermogravimeter TG-DSC 111 and show:
a difference in water adsorption of the composite material between the first and last of 5 successive cycles of less than 5%.
a difference between water adsorption and subsequent water desorption in each cycle of less than 5%.

This indicates suitability for domestic or other heating systems, for example non domestic heating systems.

### Determination of the Hygroscopic Metal Concentration at the Peripheral and Central Zones

The impregnation of a grain of the composite material of Example 3 (silica gel with calcium chloride) was analysed using a scanning electron microscope and is shown in FIG. 2.

Grains of the composite material were imprisoned in an inert resin or matrix. This was polished to provide a cross section through grains that could be analysed using an electron microscope. Chemical analysis was obtained using an EDX analyser provided with the scanning electron microscope.

During sample preparation and analysis it was ensured:
that the planarity of the surface was sufficient to provide a quantitative chemical analysis;
that the preparation technique did not bring any element that would interfere with chemical analyses (i.e. in the case of EDX, peaks should not overlap). For example, a conductive carbon layer should not be deposited before imaging if the composite contains activated carbon;
that the composite material was not contaminated by any other mean, for example, the polishing media;
that none of the elements to be measure was removed by the preparation technique (i.e., C or Si, O and Sr, Br or Ca, Cl or Mg, Cl).

Once the sample was imaged, it was verified that no “crust” of salt was present on the outer areas of the cross section. Such a crust would imply an interface between an imperfectly impregnated core and an outer area. A check using EDX can be done in case of doubt. On FIG. 2, no such phenomenon can be observed.

An analysis zone was defined across the width of a grain as an inscribed rectangle with at least three corners in contact with the grain periphery. The length of the analysis zone should be at least 1/10 of the diameter of the grain and the ratio length/width should be equal to 10. Preferably, the analysis zone passes through the centre of the grain. The analysis zone was then divided into ten identical juxtaposed squares numbered sequentially from 1 to 10, as shown in FIG. 2.

Square 1 (at the periphery of the grain) defines the peripheral zone and square 5 towards the centre of the grain defines the central zone at which the concentrations were determined. Table 2 gives the elements analysed (any other element was excluded from the analysis) and the condition used to verify a “good quality of impregnation”:

TABLE 2

| | Elements | |
|---|---|---|
| Pairing | analyses | Impregnation is of good quality if: |
| activated carbon and strontium bromide | C, Sr, Br | ${( \frac{[ Sr ]}{[ C ]} )}_{5} \geq 0.7 {( \frac{[ Sr ]}{[ C ]} )}_{1}$ |
| activated carbon and calcium chloride | C, Ca, Cl | ${( \frac{[ Ca ]}{[ C ]} )}_{5} \geq 0.7 {( \frac{[ Ca ]}{[ C ]} )}_{1}$ |
| silicagel and calcium chloride | Si, O, Ca, Cl | ${( \frac{[ Ca ]}{[ Si ]} )}_{5} \geq 0.7 {( \frac{[ Ca ]}{[ Si ]} )}_{1}$ |
| silicagel and strontium bromide | Si, O, Sr, Br | ${( \frac{[ Sr ]}{[ Si ]} )}_{5} \geq 0.7 {( \frac{[ Sr ]}{[ Si ]} )}_{1}$ |
| Silicagel and magnesium chloride | Si, O, Mg, Cl | ${( \frac{[ Mg ]}{[ Si ]} )}_{5} \geq 0.7 {( \frac{[ Mg ]}{[ Si ]} )}_{1}$ |

In Table 2, [x] denotes the mass percentage of element x and the indices “1” and “5” denote measurements performed on squares 1 and 5 respectively.

The mass percentages of Ca, Cl, Si and O were measured. On square 1, [Ca]/[Si]=0.3255 and on square 5, [Ca]/[Si]=0.6307.

Preferably, the measurement is repeated on a plurality of grains and the average is taken.

Thus, in this example the central zone hygroscopic metal concentration was 1.94 times the times the peripheral zone hygroscopic metal concentration (HMCc=1.94 HMCp); this satisfies the condition HMCc≧0.7 HMCp.

1. A composite material comprising grains, the grains comprising at least one of the following pairings of a hygroscopic salt arranged within a porous material and having the following water adsorption and/or amount of hygroscopic salt:

| | water adsorption | amount of hygroscopic salt |
|---|---|---|
| pairing of porous | measured between | of the composite material |
| material and | 80° C. and 30° C. | in the grains with respect to |
| hygroscopic salt | at 12.5 mbar | the total weight of the grains |
| activated carbon and | at least 0.19 g/g | at least 29% wt |
| strontium bromide | | |
| activated carbon and | at least 0.28 g/g | at least 32% wt |
| calcium chloride | | |
| silicagel and | at least 0.35 g/g | at least 38% wt |
| calcium chloride | | |
| silicagel and | at least 0.18 g/g | at least 47% wt |
| strontium bromide | | |
| silicagel and | at least 0.25 g/g | at least 31% wt |
| magnesium chloride | | |

wherein the grains have a peripheral zone and a central zone, the peripheral zone of a grain being a portion of the grain extending from a periphery of the grain towards the centre of the grain for a distance of about 1/10^{th} of the diameter of the grain, and the central zone of a grain being a portion of the grain extending from the centre of the grain for a distance of about 1/10^{th} of the diameter of the grain towards the periphery of the grain;
wherein the peripheral zone has a peripheral zone hygroscopic metal concentration HMCp expressed as the mass percentage of metal(s) of the hygroscopic salt(s) at the peripheral zone HMp divided by the mass percentage of i) the carbon of the activated carbon or ii) the silicon of the silica gel at the peripheral zone HPp (i.e. HMCp=HMp/HPp) wherein the central zone has a central zone hygroscopic metal concentration HMCc expressed as the mass percentage of metal(s) of the hygroscopic salt(s) at the central zone HMc divided by the mass percentage of i) the carbon of the activated carbon or ii) the silicon of the silica gel at the central zone HPc (i.e. HMCc=HMc/HPc) and wherein the central zone hygroscopic metal concentration is greater than or equal to 0.7 times the peripheral zone hygroscopic metal concentration (HMCc≧0.7 HMCp).

2. A composite material in accordance with claim 1, wherein the water adsorption of the composite material measured between 80° C. and 30° C. at 20 mbar is:
at least 0.19 g/g for the pairing activated carbon and strontium bromide
at least 0.44 g/g for the pairing activated carbon and calcium chloride
at least 0.25 g/g for the pairing silicagel and strontium bromide
at least 0.60 g/g for the pairing silicagel and calcium chloride
at least 0.35 g/g for the pairing silicagel and magnesium chloride

3. A composite material in accordance with claim 1, wherein the central zone hygroscopic metal concentration is greater than or equal to 0.8 times the peripheral zone hygroscopic metal concentration (HMCc≧0.8 HMCp).

4. A composite material in accordance with claim 1, wherein the amount of hygroscopic salt of the composite material in the grain with respect to the total weight of the grain is determined by X-ray fluorescence.

5. A composite material in accordance with claim 1, wherein the amount of hygroscopic salt of the composite material in the grains with respect to the total pore volume of the porous material in the grains is no more than 90%.

6. A composite material, notably in accordance with claim 1, comprising a pairing of a porous material and a hygroscopic salt arranged within the porous material, selected from the pairings of:
activated carbon and strontium bromide
activated carbon and calcium chloride
silicagel and calcium chloride
silicagel and strontium bromide
silicagel and magnesium chloride
wherein the difference in water adsorption of the composite material measured between 80° C. and 30° C. at 12.5 mbar or at 20 mbar between 5 successive cycles, preferably between 15 successive cycles, is less than 10%, preferably less than 5%.

7. A method of manufacturing a composite material comprising a pairing of a porous material and a hygroscopic salt arranged within the porous material, notably in accordance with any preceding claim, comprising:
Impregnating a porous material with a solution of a hygroscopic salt to form a composite material;
Subsequently drying the composite material in order to remove water;
Subsequently re-impregnating the composite material with a solution of a hygroscopic salt to form a composite material;

8. A method in accordance with claim 7, comprising at least three impregnations each separated by a drying of the composite material.

9. A method in accordance with claim 7, wherein the pairing of the hygroscopic salt and the porous material is selected from the pairings:
activated carbon and strontium bromide
activated carbon and calcium chloride
silicagel and calcium chloride
silicagel and strontium bromide
silicagel and magnesium chloride.

10. A method in accordance with claim 7, wherein the method does not comprise washing the composite material between impregnations.

11. A method in accordance with claim 7, wherein the amount of hygroscopic salt of the composite material in the grains with respect to the total weight of the composite material in the grains is at least 25% wt, preferably at least 35% wt.

12. A method of storage and recuperation of thermal energy comprising:
a) at least partially dehydrating a hydrated form of i) a composite material in accordance with claim 1, or ii) a composite material manufactured by a method in accordance with claim 1, by subjecting the composite material to a temperature in the range 30° C. to 150° C. for a period of at least 30 minutes;
b) Subsequently storing the at least partially dehydrated composite material for a period of at least 4 hours;
c) Subsequently exposing the at least partially dehydrated composite material to water to at least partially re-hydrate the composite material whilst removing heat from the composite material at a temperature in the range 20° C. to 80° C.

13. A method in accordance with claim 12, wherein:
a) at least partially dehydrating the composite material comprises subjecting the composite material to a temperature in the range 70° C. to 100° C. for a period of least 30 minutes; and
b) at least partially hydrating the composite material comprises removing heat at a temperature in the range 30° C. to 80° C.

14. A domestic heating system comprising:
a) a composite material in accordance with claim 1, or ii) a composite material manufactured by a method in accordance with claim 1;
b) a system for at least partially dehydrating the composite material by subjecting the composite material to a temperature in the range 30° C. to 150° C. for a period of at least 30 minutes;
c) a system for storing the at least partially dehydrated composite material for a period of at least 4 hours;
d) a system for exposing the at least partially dehydrated composite material to water to at least partially re-hydrate the composite material whilst removing heat from the composite material at a temperature in the range 20° C. to 80° C.

15. A heating system in accordance with claim 14, in which the heating system is adapted to store at least 2000 kWh of energy for a duration of at least 3360 hours (about 140 weeks).
